(19) United States
(12) Patent Application Publication
(10) Pub. No.: US 2019/0337169 A1
(43) Pub. Date: Nov. 7, 2019

(54) Cutting Apparatus with Folding Arrangement

(71) Applicant: ARTISANCUTLERY INC., Chino Hills, CA (US)

(72) Inventor: Weide WANG, Chino Hills, CA (US)

(21) Appl. No.: 16/396,544

(22) Filed: Apr. 26, 2019

(30) Foreign Application Priority Data
May 2, 2018 (CN) 201820643265.7

(51) Int. Cl. B26B 11/00

(52) U.S. Cl. CPC B26B 11/003; B26B 11/006

(57) ABSTRACT

A cutting apparatus includes a main blade, a first handle having a first connecting portion, a second handle having a second connecting portion, and a folding arrangement which includes a folding base. The cutting apparatus can be operated between an unfolded portion and a folded position, wherein in the unfolded position, the first handle and the second handle are pivotally unfolded with respect to the folding base to extend in a direction opposite to that of the main blade so as to act as handles to the main blade, whereas in the folded position, the first handle and the second handle are pivotally folded with respect to the folding base toward the main blade so as to form a protective cover for the main blade.

### BACKGROUND OF THE PRESENT INVENTION

### Field of Invention

The present invention relates to a cutting apparatus, and more particularly to a cutting apparatus comprising a folding arrangement which allows a first handle and a second handle to be selectively, pivotally and single handedly unfolded to form a handle for a main blade, and to be pivotally folded to form a compact structure.

### Description of Related Arts

Foldable cutting apparatuses, such as foldable knives, are very poplar all over the world. A conventional foldable cutting apparatus usually comprises a handle and a cutting blade pivotally connected to the handle such that the cutting blade may be pivotally folded to be received in the handle, or pivotally unfolded for use in cutting objects.

A main disadvantage related to the above-mentioned foldable cutting apparatuses is that when the foldable cutting apparatuses are ready to be unfolded, a user typically need both hands to unfold the corresponding cutting blade. This may impart inconvenience in certain circumstances. This problem also exists in foldable cutting apparatuses having two handle members. Conventionally, when a user wishes to use the cutting blade, he or she needs to manually move apart the two handle members which embed the cutting blade so as to allow the cutting blade to be exposed to ambient environment. In certain circumstances, however, unfolding the cutting apparatuses by using both hands impart inconvenience and may cause unwanted delay in some situations.

As a result, there is a need to develop a cutting apparatus which is capable of allowing a user to unfold a cutting blade by using only one hand.

### SUMMARY OF THE PRESENT INVENTION

Certain variations of the present invention provide a cutting apparatus comprising a folding arrangement which allows a first handle and a second handle to be selectively, pivotally and single handedly unfolded to form a handle for a main blade, and to be pivotally folded to surround a main blade and to form a compact structure.

In one aspect of the present invention, it provides a cutting apparatus, comprising:

a main blade having a distal end portion and a proximal end portion;

a first handle having a first connecting portion;

a second handle having a second connecting portion; and

a folding arrangement which comprises a folding base having a first peripheral pivot portion, a second peripheral pivot portion and a central portion, the proximal end portion of the main blade connecting to the central portion of the folding base, the first connecting portion of the first handle pivotally connecting to the first peripheral pivot portion of the folding base, the second connecting portion of the second handle pivotally connecting to the second peripheral pivot portion of the folding base, the cutting apparatus being operated between an unfolded portion and a folded position, wherein in the unfolded position, the first handle and the second handle are pivotally unfolded with respect to the folding base to extend in a direction opposite to that of the main blade so as to act as handles to the main blade, wherein in the folded position, the first handle and the second handle are pivotally folded with respect to the folding base toward the main blade so as to form a protective cover for the main blade.

This summary presented above is provided merely to introduce certain concepts and not to identify any key or essential features of the claimed subject matter.

### BRIEF DESCRIPTION OF THE DRAWINGS

FIG. 1 is a front perspective view of a cutting apparatus according to a preferred embodiment of the present invention.

FIG. 2 is a rear perspective view of a cutting apparatus according to a preferred embodiment of the present invention.

FIG. 3 is a front exploded perspective view of the cutting apparatus according to the preferred embodiment of the present invention.

FIG. 4 is a schematic diagram of the cutting apparatus according to the preferred embodiment of the present invention, illustrating the cutting apparatus is in the folded position.

FIG. 5 is a front view of the cutting apparatus according to the preferred embodiment of the present invention, illustrating the cutting apparatus is in the unfolded position.

FIG. 6 is a schematic diagram of the cutting apparatus according to the preferred embodiment of the present invention, illustrating the cutting apparatus is being unfolded.

FIG. 7 is a rear view of the cutting apparatus according to the preferred embodiment of the present invention.

FIG. 8 is a schematic diagram of a locking latch according to the preferred embodiment of the present invention.

### DETAILED DESCRIPTION OF THE PREFERRED EMBODIMENT

The following detailed description of the preferred embodiment is the preferred mode of carrying out the invention. The description is not to be taken in any limiting sense. It is presented for the purpose of illustrating the general principles of the present invention.

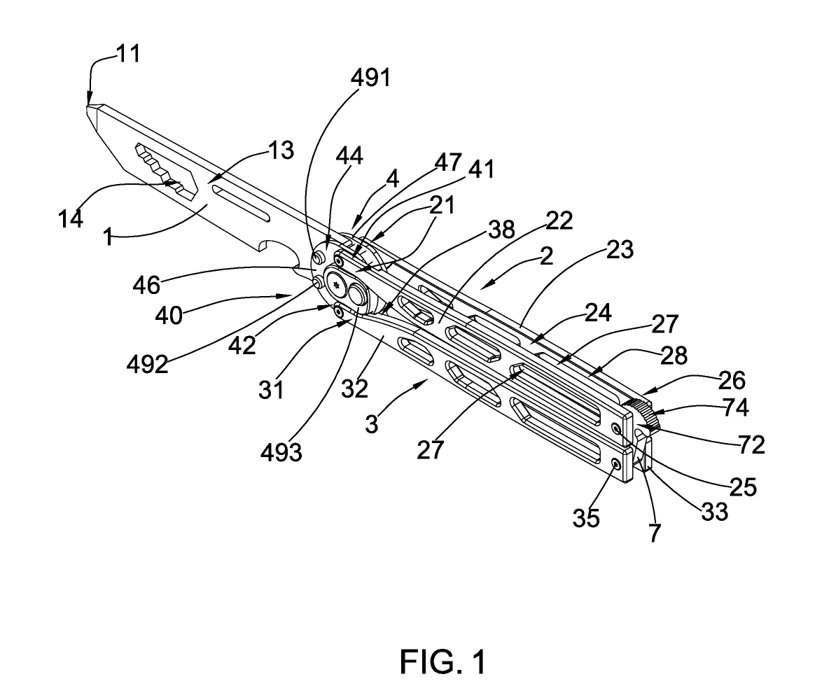

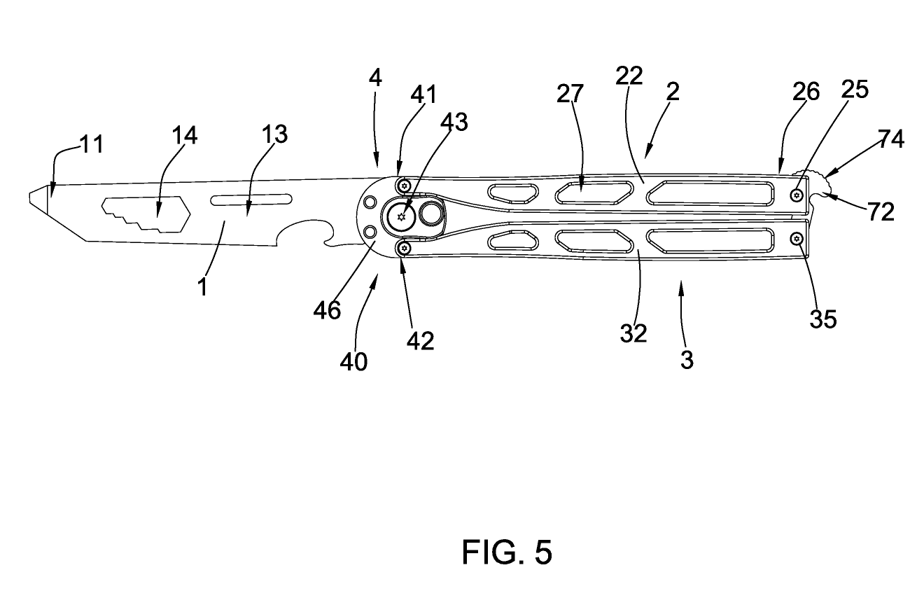

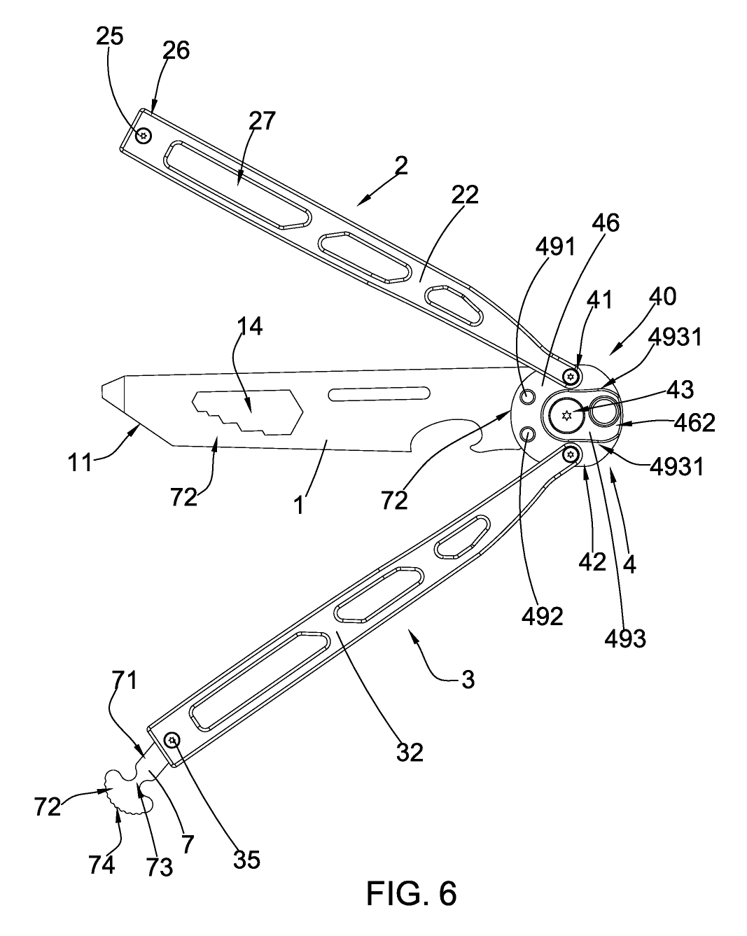

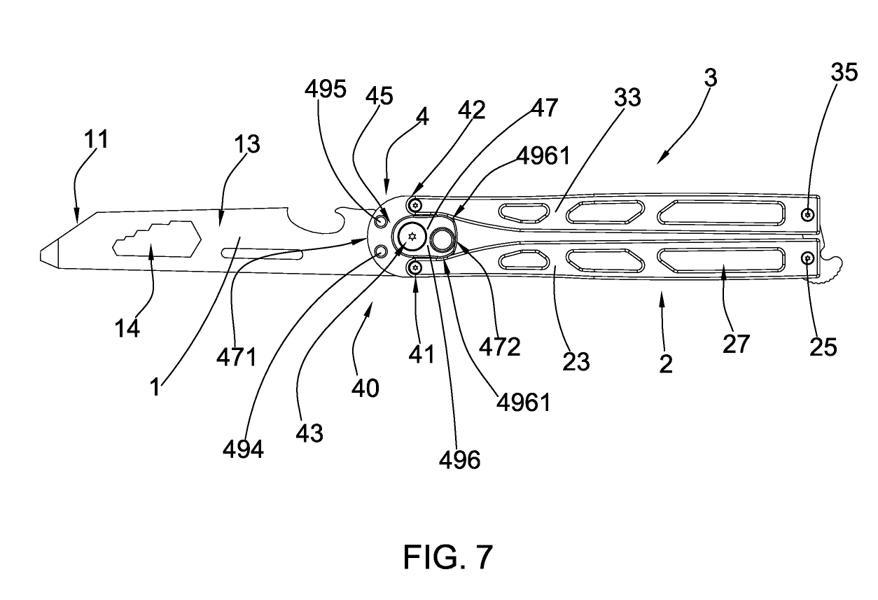

Referring to FIGS. 1 to 8 of the drawings, a cutting apparatus according to a preferred embodiment of the present invention is illustrated. Broadly, the cutting apparatus may comprise a main blade 1 having a distal end portion 11 and a proximal end portion 12, a first handle 2, a second handle 3, and a folding arrangement 40 comprising a folding base 4.

The first handle 2 may have a first connecting portion 21 while the second handle 3 may have a second connecting portion 31.

The folding base 4 of the folding arrangement 40 may have a first peripheral pivot portion 41, a second peripheral pivot portion 42 and a central portion 43. The proximal end portion 12 of the main blade 1 may be connected to the central portion 43 of the folding base 4. The first connecting portion 21 of the first handle 2 may be pivotally connected to the first peripheral pivot portion 41 of the folding base 4. The second connecting portion 31 of the second handle 3 may be pivotally connected to the second peripheral pivot portion 42 of the folding base 4.

The cutting apparatus may be operated between an unfolded portion and a folded position, wherein in the unfolded position, the first handle 2 and the second handle 3 may be pivotally unfolded with respect to the folding base 4 to extend in a direction opposite to that of the main blade 1 so as to act as handles to the main blade 1, wherein in the folded position, the first handle 2 and the second handle 3 may be pivotally folded with respect to the folding base 4 toward the main blade 1 so as to form a protective cover for the main blade 1 and a compact structure for the entire cutting apparatus.

According to the preferred embodiment of the present invention, the main blade 1 may further have a utility portion 13 extended between the distal end portion 11 and the proximal end portion 12 for performing various utility functions. The main blade 1 may further have a plurality of utility slots 14 formed on the utility portion 13, wherein each of the utility slots 14 may be specifically shaped and designed to perform specific functions. For example, one utility slot 14 may be shaped and crafted to open beer cans.

As shown in FIG. 1 to FIG. 3 of the drawings, a front view of the cutting apparatus is illustrated. The proximal end portion 12 of the main blade 1 may be securely connected to the central portion 43 of the folding base 4 so that there is no relative movement (pivotal or lateral) between the main blade 1 and the folding base 4.

The first handle 2 may have a first accommodating cavity 24 for partially receiving the main blade 1 when the cutting apparatus is in the folded position so as to form a barrier or boundary between the main blade 1 and ambient environment. Specifically, the first handle 2 may comprise a first front handle piece 22 and a first rear handle piece 23 pivotally connected to a front surface 44 and a rear surface 45 of the folding base 4 respectively at the first peripheral pivot portion 41 thereof. Each of the first front handle piece 22 and the first rear handle piece 23 may have a planar and elongated structure so that when they are pivotally connected to the front surface 44 and the rear surface 45 of the folding base 4 respectively, the first accommodating cavity 24 may be formed between the first front handle piece 22 and the first rear handle piece 23. The first handle 2 may further have a two first side openings 28 formed as two side openings of the first accommodating cavity 24. Thus, the two first side openings 28 may communicate the first accommodating cavity 24 with an exterior of the first handle 2.

The first handle 2 may further comprise a first connecting member 25 extended between the first front handle piece 22 and the first rear handle piece 23 for securely connecting the first front handle piece 22 and the first rear handle piece 23. The first connecting member 25 may be configured as a connecting pin connecting between the first front handle piece 22 and the first rear handle piece 23 preferably at a first free end portion 26 of the first handle 2. Note that the first handle 2 may further has a plurality of first through handle slots 27 formed on the first front handle piece 22 and the first rear handle piece 23 for aesthetical and utility purposes. For example, each of the first through handle slots 27 may allow a user to hang the cutting apparatus on an external object.

Furthermore, each of the first front handle piece 22 and the first rear handle piece 23 may have a contracted portion which together form the first connecting portion 21 of the first handle 2. The first front handle piece 22 may be pivotally connected to the front surface 44 of the folding base 4 on the first peripheral pivot portion 41, while the first rear handle piece 23 may be pivotally connected to the rear surface 45 of the folding base 4 also on the first peripheral pivot portion 41. In other words, the first peripheral pivot portion 41 may be sandwiched between the first front handle piece 22 and the first rear handle piece 23 at the first connecting portion 21, as shown in FIG. 1 of the drawings.

Similarly, the second handle 3 may have a second accommodating cavity 34 for partially receiving the main blade 1 when the cutting apparatus is in the folded position so as to form a barrier or boundary between the main blade 1 and ambient environment. Specifically, the second handle 3 may comprise a second front handle piece 32 and a second rear handle piece 33 pivotally connected to a front surface 44 and a rear surface 45 of the folding base 4 respectively at the second peripheral pivot portion 42 thereof. Each of the second front handle piece 32 and the second rear handle piece 33 may have a planar and elongated structure so that when they are pivotally connected to the front surface 44 and the rear surface 45 of the folding base 4 respectively, the second accommodating cavity 34 may be formed between the second front handle piece 32 and the second rear handle piece 33. The second handle 3 may further have a two second side openings 38 formed as two side openings of the second accommodating cavity 34. Thus, the two second side openings 38 may communicate the second accommodating cavity 34 with an exterior of the second handle 3.

The second handle 3 may further comprise a second connecting member 35 extended between the second front handle piece 32 and the second rear handle piece 33 for securely connecting the second front handle piece 32 and the second rear handle piece 33. The second connecting member 35 may also be configured as a connecting pin connecting between the second front handle piece 32 and the second rear handle piece 33 preferably at a second free end portion 36 of the second handle 3. Note that the second handle 3 may further has a plurality of second through handle slots 37 formed on the second front handle piece 32 and the second rear handle piece 33 for aesthetical and utility purposes. For example, each of the second through handle slots 37 may allow a user to hang the cutting apparatus on an external object.

Furthermore, each of the second front handle piece 32 and the second rear handle piece 33 may have a contracted portion which together form the second connecting portion 31 of the second handle 3. The second front handle piece 32 may be pivotally connected to the front surface 44 of the folding base 4 on the second peripheral pivot portion 42, while the second rear handle piece 33 may be pivotally connected to the rear surface 45 of the folding base 4 also on the second peripheral pivot portion 42. In other words, the second peripheral pivot portion 42 may be sandwiched between the second front handle piece 32 and the second rear handle piece 33 at the second connecting portion 31. Each of the first connecting member 25 and the second connecting member 35 may preferably have a circular cross-sectional shape. Other cross sectional shapes of the first connecting member 25 and the second connecting member 35 are also possible.

Referring to FIG. 1 to FIG. 4 of the drawings, when the cutting apparatus is in the unfolded position, the first handle 2 and the second handle 3 may be arranged to be pivotally moved in a side-by-side configuration. On the other hand, when the cutting apparatus is in the folded position, the first handle 2 and the second handle 3 may be arranged to be pivotally moved to sandwich and embed the main blade 1.

The folding arrangement 40 may further comprise a locking latch 7 pivotally connected to one of the first handle 2 and the second handle 3, wherein the locking latch 7 may be arranged to pivotally engage with the other handle so as to lock a lateral and pivotal movement of the first handle 2 and the second handle 3. In other words, the locking latch 7 may be arranged to retain the cutting apparatus in either the folded position or the unfolded position.

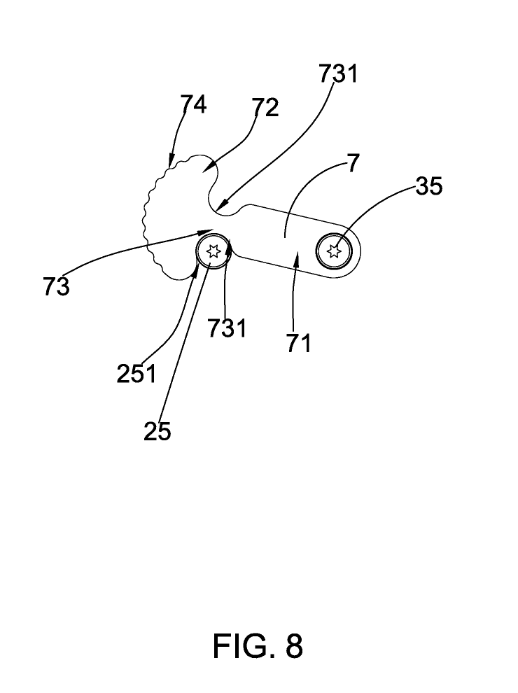

According to the preferred embodiment of the present invention, the locking latch 7 may be pivotally connected to the second connecting member 35 of the second handle 3 so that the locking latch 7 may pivotally move with respect to the second front handle piece 32 and the second rear handle piece 33. As shown in FIG. 8 of the drawings, the locking latch 7 may have a contracted portion 71 pivotally connected to the second connecting member 35, an enlarged portion 72, and an engagement portion 73 extended between the contracted portion 71 and the enlarged portion 72. A width of the contracted portion 71 is greater than that of the engagement portion 73 while a width of the enlarged portion 72 is greater than that of the contracted portion 71 and the engagement portion 73. The engagement portion 73 has two curved engagement surfaces 731 wherein a radius of curvature of each of these engagement surfaces 731 may be substantially the same as a radius of curvature of an external circumferential surface 251 of the first connecting member 25, so that when the locking latch 7 is pivotally moved to engage with the first connecting member 25, the corresponding engagement surface 731 may fittedly engage with the external circumferential surface 251 of the first connecting member 25.

When the locking latch 7 is pivotally moved to engage with the second connecting member 35, the engagement portion 73 is arranged to engage with the corresponding external circumferential surface 251 while the enlarged portion 72 may prevent the locking latch 7 from disengaging from the first connecting member 25. This ensures that the locking latch 7 may retain the cutting apparatus in either the folded position or the unfolded position. Moreover, the locking latch 7 may further have a plurality of teeth 74 formed on an external surface of the enlarged portion 72 for increasing frictional force between the enlarged portion and a user's hand when it comes into contact with the teeth 74 for unfolding the cutting apparatus of the present invention.

The folding base 4 may comprise a front base member 46 and a rear base member 47 connected to the front base member 46 at a distance so as to create a base cavity 48 formed as the space between the front base member 46 and the rear base member 47, wherein the proximal end portion 12 of the main blade 1 is accommodated in the base cavity 48 and connected to the front base member 46 and the rear base member 47 in the base cavity 48, preferably through a plurality of connecting screws. The front surface 44 of the folding base 4 may be formed as an outer surface of the front base member 46, while the rear surface 45 of the folding base 4 may be formed as an outer surface of the rear base member 47.

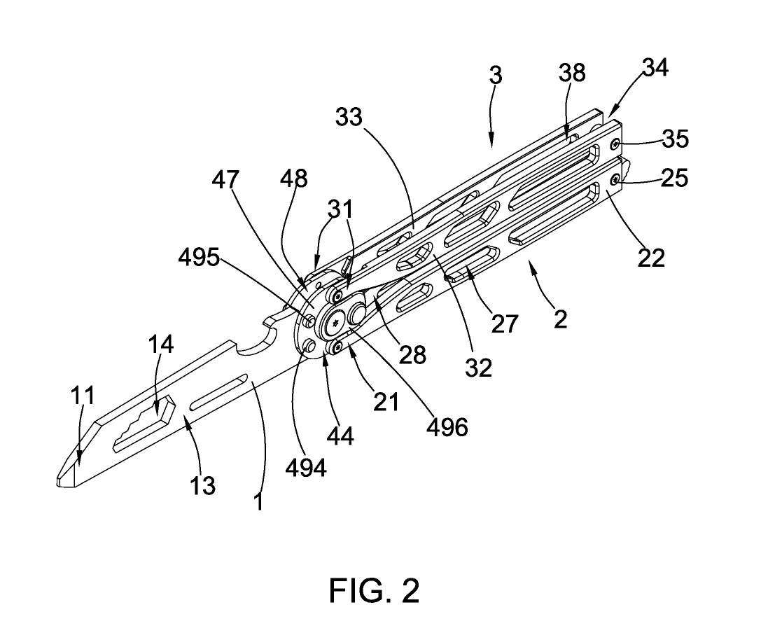

Referring to FIG. 1 to FIG. 2 of the drawings, for the first handle 2, the first front handle piece 22 may be pivotally connected to the front base member 46 while the first rear handle piece 23 may be pivotally connected to the rear base member 47.

The folding base 4 may further comprise a plurality of securing members formed on the front base member 46 and the rear base member 47 for restricting a movement of the first handle 2 and the second handle 3. Thus, the securing members may also help in retaining the cutting apparatus at either the folded position or the unfolded position.

According to the preferred embodiment of the present invention, the securing members may be protruded from front base member 46 and the rear base member 47 respectively to form physical barriers for restricting further pivotal movement of the first handle 2 and the second handle 3. In this preferred embodiment, there may exist altogether six securing members, three of which may be frontwardly protruded from the front base member 46, while the remaining three may be rearwardly protruded from the rear base member 47. For the sake of convenience, the securely members 49 may be termed first through six securing members 491, 492, 493, 494, 495, 496, wherein the first through third securing member 491, 492, 493 may be frontwardly protruded from the front base member 46, and the fourth through sixth securing members 494, 495, 496 may be rearwardly protruded from the rear base member 47.

The first securing member 491 and the second securing member 492 may be configured as having a cylindrical structure which may be protruded from the first base member 46 at positions in the vicinity of a top circumferential edge 461 thereof near the main blade 1. On the other hand, the third securing member 493 may be protruded from the first base member 46 at a position in the vicinity of a bottom circumferential edge 462 thereof near the first handle 2 and the second handle 3.

The third securing member 493 may be configured as having a curved cross sectional shape when viewed from the front and may have a cross sectional surface area substantially larger than that of the first securing member 491 and the second securing member 492. The third securing member 493 may have two side biasing surfaces 4931 arranged to bias against the first front handle piece 22 and the second front handle piece 32 when they are pivotally unfolded so as to restrict further pivotally movement of the first handle 2 and the second handle 3. On the other hand, when the first handle 2 and the second handle 3 are pivotally folded towards the main blade 1, the first securing member 491 and the second securing member 492 may be arranged to bias against the first front handle piece 22 and the second front handle piece 32.

On the other hand, the fourth securing member 494 and the fifth securing member 495 may be configured as having a cylindrical structure which may be protruded from the second base member 47 at positions in the vicinity of a top circumferential edge 471 thereof near the main blade 1. On the other hand, the sixth securing member 496 may be protruded from the second base member 47 at a position in the vicinity of a bottom circumferential edge 472 thereof near the first handle 2 and the second handle 3.

The sixth securing member 496 may be configured as having a curved cross sectional shape when viewed from the rear and may have a cross sectional surface area substantially larger than that of the fourth securing member 494 and the fifth securing member 495. The sixth securing member 496 may have two side biasing surfaces 4961 arranged to bias against the first rear handle piece 23 and the second rear handle piece 33 when they are pivotally unfolded so as to restrict further pivotally movement of the first handle 2 and the second handle 3. On the other hand, when the first handle 2 and the second handle 3 are pivotally folded towards the main blade 1, the fourth securing member 494 and the fifth securing member 495 may be arranged to bias against the first rear handle piece 23 and the second rear handle piece 33.

It is worth mentioning that the first securing member 491, the second securing member 492, the fourth securing member 494, and the fifth securing member 495 may have identical structure, wherein the first securing member 491 may be longitudinally aligned with the fourth securing member 494, while the second securing member 492 may be longitudinally aligned with the fifth securing member 495.

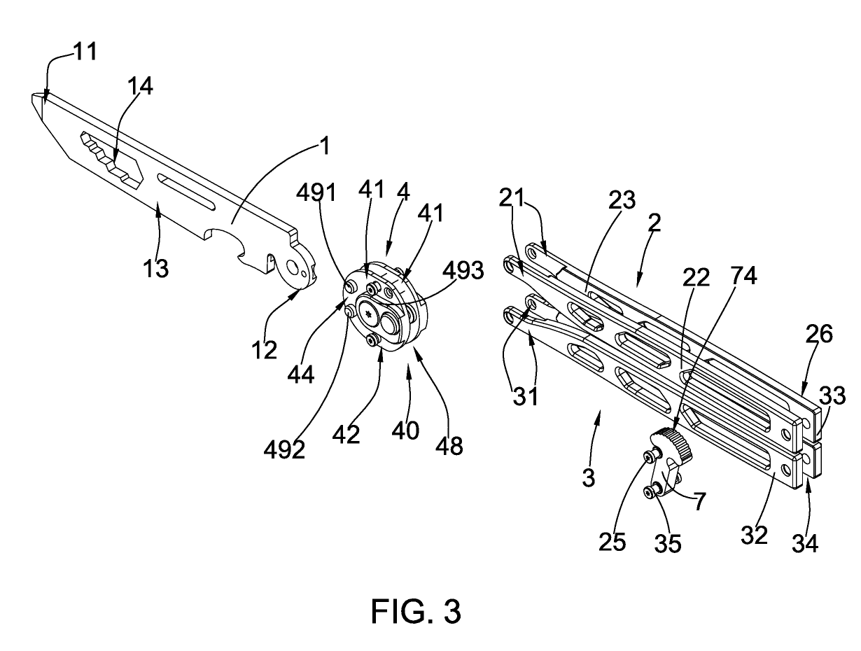

The operation of the present invention is as follows: the cutting apparatus may normally be in folded position. When the cutting apparatus is in the folded position, each of the first handle 2 and the second handle 3 may be pivotally folded toward the main blade 1 in such a manner that the main blade 1 may be received in the first accommodating cavity 24 and the second accommodating cavity 34, as shown in FIG. 3 of the drawings. The pivotal movement of the first handle 2 may be accomplished by pivotally moving the first front handle piece 22 and the first rear handle piece 23 with respect to first peripheral pivot portion 41 of the folding base 4. On the other hand, the pivotal movement of the second handle 3 may be accomplished by pivotally moving the second front handle piece 32 and the second rear handle piece 33 with respect to second peripheral pivot portion 42 of the folding base 4.

Since the main blade 1 may be received in the first accommodating cavity 24 and the second accommodating cavity 34, a length of the first accommodating cavity 24 and the second accommodating cavity 34 may be longer than that of the main blade 1.

When the first handle 2 and the second handle 3 are pivotally folded toward the main blade 1, they may continue the pivotal movement until biasing against the first securing member 491, the second securing member 492, the fourth securing member 494 and the fifth securing member 495. At that point, the first handle 2 and the second handle 3 may be prevented from pivotally moving further. Specifically, the first front handle piece 22 may be arranged to bias against the first securing member 491, whereas the second front handle piece 32 may be arranged to bias against the second securing member 492. On the other hand, the first rear handle piece 23 may be arranged to bias against the fourth securing member 494 whereas the second rear handle piece 33 may be arranged to bias against the fifth securing member 495.

When the cutting apparatus is in the folded position, an overall size of the cutting apparatus will be substantially reduced. Moreover, the locking latch 7 may also be pivotally moved so that the engagement portion 73 may engage with the second connecting member 35 of the second handle 3 so as to lock further pivotal movement between the first handle 2 and the second handle 3. When a user wishes to turn the cutting apparatus from the folded position to the unfolded position, he may need to manually disengage the engagement portion 73 from the second connecting member 35 before he may pivotally unfold the first handle 2 and the second handle 3.

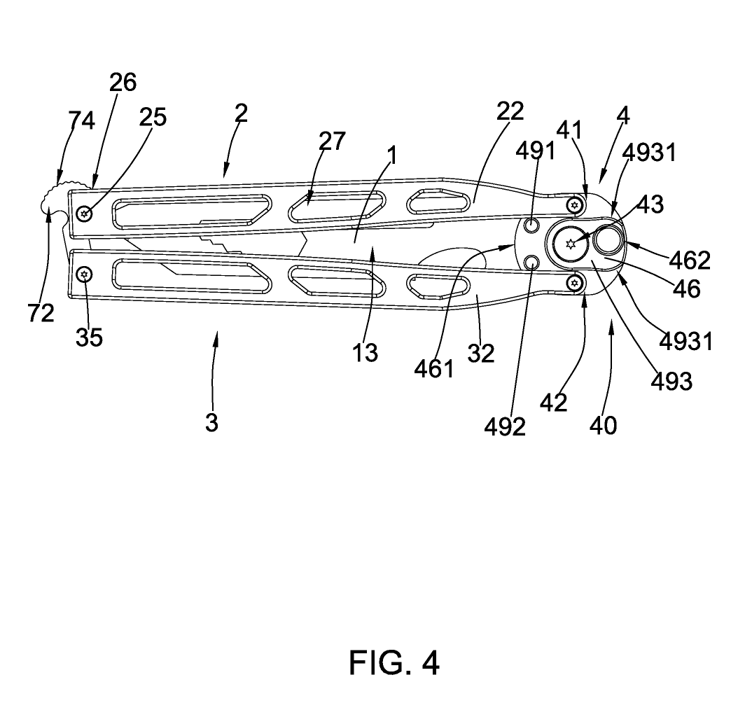

When the cutting apparatus is in the unfolded position, the first handle 2 and the second handle 3 may be pivotally moved away from the main blade 1 with respect to the folding base 4, so that the main blade 1 may expose to ambient environment and the first handle 2 and the second handle 3 may be pivotally moved to extend in an opposite direction to the main blade 1. The first handle 2 and the second handle 3 may be pivotally moved until they are in a side-by-side configuration with respect to each other. At the same time, the first front handle piece 22 may bias against the corresponding side biasing surface 4931 of the third securing member 493 while the second front handle piece 32 may bias against another corresponding side biasing surface 4931 of the third securing member 493. Moreover, the second front handle piece 23 may bias against the corresponding side biasing surface 4961 of the sixth securing member 496 while the second rear handle piece 33 may bias against another corresponding side biasing surface 4961 of the sixth securing member 496. As such, further pivotal movement of the first handle 2 and the second handle 3 may be restricted, as shown in FIG. 4 of the drawings.

When the first handle 2 and the second handle 3 is pivotally unfolded, the locking latch 7 may also be pivotally moved so that the engagement portion 73 may engage with the second connecting member 35 of the second handle 3 so as to lock further pivotal movement between the first handle 2 and the second handle 3. When a user wishes to turn the cutting apparatus from the unfolded position back to the folded position, he may need to manually disengage the engagement portion 73 from the second connecting member 35 before he may pivotally fold the first handle 2 and the second handle 3. Note that the pivotal movement (i.e. clockwise or anti-clockwise direction) of the locking latch 7 to lock the first handle 2 and the second handle 3 may be opposite when the cutting apparatus is in the folded position and in the unfolded position. That means when the cutting apparatus is in the folded position, clockwise pivotal movement may be required whereas in the unfolded position, anti-clockwise pivotal movement may be required for the locking latch 7.

The advantage of the cutting apparatus of the present invention is that when the cutting apparatus is in the folded position, a user may be able to use only one hand to disengage the locking latch 7 from the second handle 3 and exert a slight pivotal force to the entire cutting apparatus for pivotally unfolding the first handle 2 and the second handle 3. After that, a user may be able to hold both the first handle 2 and the second handle 3 and use the main blade 1. All these actions may be performed single handedly.

The present invention, while illustrated and described in terms of a preferred embodiment and several alternatives, is not limited to the particular description contained in this specification. Additional alternative or equivalent components could also be used to practice the present invention.

What is claimed is:

1. A cutting apparatus, comprising:
a main blade having a distal end portion and a proximal end portion;
a first handle having a first connecting portion;
a second handle having a second connecting portion; and
a folding arrangement which comprises a folding base having a first peripheral pivot portion, a second peripheral pivot portion and a central portion, said proximal end portion of said main blade connecting to said central portion of said folding base, said first connecting portion of said first handle pivotally connecting to said first peripheral pivot portion of said folding base, said second connecting portion of said second handle pivotally connecting to said second peripheral pivot portion of said folding base, said cutting apparatus being operated between an unfolded portion and a folded position, wherein in said unfolded position, said first handle and said second handle are pivotally unfolded with respect to said folding base to extend in a direction opposite to that of said main blade so as to act as handles to said main blade, wherein in said folded position, said first handle and said second handle are pivotally folded with respect to said folding base toward said main blade so as to form a protective cover for said main blade.

2. The cutting apparatus, as recited in claim 1, wherein said folding base comprises a front base member and a rear base member connected to said front base member at a distance so as to create a base cavity formed as a space between said front base member and said rear base member, wherein a proximal end portion of said main blade is accommodated in said base cavity and connected to said front base member and said rear base member in said base cavity, wherein said front surface of said folding base is formed as an outer surface of said front base member, while said rear surface of said folding base is formed as an outer surface of said rear base member.

3. The cutting apparatus, as recited in claim 2, wherein said folding base further comprise a first through third securing members frontwardly protruded from said front base member, and said fourth through sixth securing members rearwardly protruded from said rear base member.

4. The cutting apparatus, as recited in claim 3, wherein each of said first securing member and said second securing member is configured as having a cylindrical structure which is protruded from said first base member at positions in said vicinity of a top circumferential edge thereof near said main blade, said third securing member protruding from said first base member at a position in a vicinity of a bottom to circumferential edge thereof near said first handle and said second handle.

5. The cutting apparatus, as recited in claim 4, wherein said first handle has a first accommodating cavity for partially receiving said main blade when said cutting apparatus is in said folded position, said first handle comprising a first front handle piece and a first rear handle piece pivotally connected to a front surface and a rear surface of said folding base respectively at said first peripheral pivot portion thereof, said first accommodating cavity being formed between said first front handle piece and said first rear handle piece.

6. The cutting apparatus, as recited in claim 5, wherein said third securing member is configured as having a curved cross sectional shape and has a cross sectional surface area substantially larger than that of said first securing member and said second securing member, said third securing member having two side biasing surfaces arranged to bias against said first front handle piece and said second front handle piece when said first handle and said second handle are pivotally unfolded so as to restrict further pivotally movement of said first handle and said second handle.

7. The cutting apparatus, as recited in claim 6, wherein each of said fourth securing member and said fifth securing member is configured as having a cylindrical structure which is protruded from said second base member at positions in a vicinity of a top circumferential edge thereof near said main blade.

8. The cutting apparatus, as recited in claim 7, wherein said second handle has a second accommodating cavity for partially receiving said main blade when said cutting apparatus is in said folded position, said second handle comprising a second front handle piece and a second rear handle piece pivotally connected to a front surface and a rear surface of said folding base respectively at said second peripheral pivot portion thereof, said second accommodating cavity being formed between said second front handle piece and said second rear handle piece.

9. The cutting apparatus, as recited in claim 8, wherein said sixth securing member is configured as having a curved cross sectional shape and has a cross sectional surface area substantially larger than that of said fourth securing member and said fifth securing member, said sixth securing member having two side biasing surfaces arranged to bias against said first rear handle piece and said second rear handle piece when said first handle and said second handle are pivotally unfolded so as to restrict further pivotally movement of said first handle and said second handle.

10. The cutting apparatus, as recited in claim 9, wherein said folding arrangement further comprises a locking latch pivotally connected to one of said first handle and said second handle, wherein said locking latch is arranged to pivotally engage with said other handle so as to lock a lateral and pivotal movement of said first handle and said second handle.

11. The cutting apparatus, as recited in claim 10, wherein said first handle further comprises a first connecting member extended between said first front handle piece and said first rear handle piece for securely connecting said first front handle piece and said first rear handle piece.

12. The cutting apparatus, as recited in claim 11, wherein said second handle further comprises a second connecting member extended between said second front handle piece and said second rear handle piece for securely connecting said second front handle piece and said second rear handle piece.

13. The cutting apparatus, as recited in claim 12, wherein said locking latch is pivotally connected to said second connecting member of said second handle so that said locking latch pivotally moves with respect to said second front handle piece and said second rear handle piece.

14. The cutting apparatus, as recited in claim 13, wherein said locking latch has a contracted portion pivotally connected to said second connecting member, an enlarged portion, and an engagement portion extended between said contracted portion and said enlarged portion, a width of said contracted portion being greater than that of said engagement portion while a width of said enlarged portion being greater than that of said contracted portion and said engagement portion, said engagement portion having two curved engagement surfaces in which a radius of curvature of each of said two curved engagement surfaces is substantially the same as a radius of curvature of an external circumferential surface of said first connecting member, so that when said locking latch is pivotally moved to engage with said first connecting member, said corresponding engagement surface is arranged to fittedly engage with said external circumferential surface of said first connecting member.

15. The cutting apparatus, as recited in claim 14, wherein said locking latch further has a plurality of teeth formed on an external surface of said enlarged portion for increasing frictional force between said enlarged portion and a user's hand.
